(19) United States
(12) Patent Application Publication
(10) Pub. No.: US 2021/0303105 A1
(43) Pub. Date: Sep. 30, 2021

(54) INFORMATION DISPLAY SYSTEM AND INFORMATION DISPLAY METHOD

(71) Applicant: Panasonic Intellectual Property Management Co., Ltd., Osaka (JP)

(72) Inventors: Chinatsu YONEYAMA, Kanagawa Ken (JP); Takuma IIDA, Kanagawa Ken (JP); Masashi FUMOTO, Kanagawa Ken (JP)

(73) Assignee: Panasonic Intellectual Property Management Co., Ltd., Osaka (JP)

(21) Appl. No.: 16/951,567

(22) Filed: Nov. 18, 2020

(30) Foreign Application Priority Data
Mar. 30, 2020 (JP) 2020-061068

(51) Int. Cl. G06F 3/0481; G06Q 10/06; G06Q 30/02; G06Q 50/30

(52) U.S. Cl. CPC G06F 3/0481; G06Q 50/30; G06Q 30/0283; G06Q 10/06312

(57) ABSTRACT

An information display system according to the present disclosure includes a memory and a hardware processor coupled to the memory. The processor is configure to refer to associated information in which each identification information identifying an immovable or a movable is associated with information on the immovable or the movable, to identify information corresponding to a timing with respect to which the associated information is to be referred to, from among the information associated with the immovable or the movable on map information indicating information representing a map, and perform control to display the identified information at a position corresponding to the immovable or the movable associated with the identified information in the map information.

### CROSS-REFERENCE TO RELATED APPLICATIONS

This application is based upon and claims the benefit of priority from Japanese Patent Application No. 2020-061068, filed on Mar. 30, 2020, the entire contents of which are incorporated herein by reference.

### FIELD

Embodiments described herein relate generally to an information display system and an information display method.

### BACKGROUND

Techniques that display information on immovables (business content and business hours of a shop, for example) on a map have conventionally be known. A technique that displays information on the layout of shops and movement routes within a facility or the like on a map has been known, for example (refer to Japanese Laid-open Patent Publication No. 2013-53982, for example).

However, the conventional techniques cannot display information on movables (mobile sales cars or the like) on a map. As to the information on immovables, the content displayed on the map are always the same; for a shop changing its business category between daytime and night time, for example, different pieces of information between daytime and night time cannot be displayed on the map.

The present disclosure has been made in view of the above, and an object thereof is to provide an information display system and an information display method that can display information on an immovable or a movable that changes with the lapse of time on a map.

### SUMMARY

In order to achieve the object, an information display system according to the present disclosure includes a memory and a hardware processor coupled to the memory. The processor is configure to refer to associated information in which each identification information identifying an immovable or a movable is associated with information on the immovable or the movable, to identify information corresponding to a timing with respect to which the associated information is to be referred to, from among the information associated with the immovable or the movable on map information indicating information representing a map, and perform control to display the identified information at a position corresponding to the immovable or the movable associated with the identified information in the map information.

### BRIEF DESCRIPTION OF THE DRAWINGS

FIG. 1 is a block diagram of an exemplary configuration of an information display system according to a first embodiment;

FIG. 2 is a block diagram of an exemplary hardware configuration of a cloud server according to the first embodiment;

FIG. 3 is a block diagram of an exemplary functional configuration of the cloud server according to the first embodiment;

FIG. 4A is a diagram of an exemplary screen for a business entity to input business content and the like of a shop;

FIG. 4B is a diagram of an exemplary screen displaying information on the shop registered by the business entity on a map;

FIG. 5A is a diagram of an exemplary screen for the business entity to input business content of a vehicle;

FIG. 5B is a diagram of an exemplary screen displaying information on the vehicle registered by the business entity on the map;

FIG. 6A is a diagram of an exemplary screen designating a date and time on an input system;

FIG. 6B is a diagram of an exemplary screen designating the date and time on a scroll system;

FIG. 6C is a diagram of an exemplary screen designating the date and time on a preview system;

FIG. 7 is a diagram of an exemplary screen representing business content of vehicles standing at stopping positions with symbols;

FIG. 8 is a sequence diagram of exemplary processing by the information processing system according to the first embodiment;

FIG. 9 is a block diagram of an exemplary configuration of the information display system according to the second embodiment;

FIG. 10 is a block diagram of an exemplary functional configuration of the cloud server according to the second embodiment;

FIG. 11 is a diagram of an exemplary input screen for a delivery condition;

FIG. 12 is a diagram of an exemplary delivery screen to be delivered to the business entity;

FIG. 13 is a sequence diagram of exemplary processing by the information processing system according to the second embodiment;

FIG. 14 is a block diagram of an exemplary functional configuration of the cloud server according to the second embodiment;

FIG. 15 is a diagram of an exemplary input screen for a temporary shop opening application and an exemplary judgement result of availability judgement; and

FIG. 16 is a sequence diagram of exemplary processing by the information processing system according to a third embodiment.

### DETAILED DESCRIPTION

The following describes an information display system according to embodiments of the present disclosure in detail with reference to the accompanying drawings.

### First Embodiment

Configuration of Information Display System According to First Embodiment

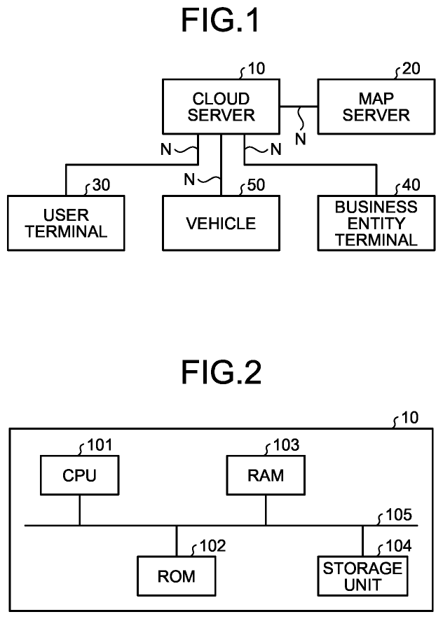

FIG. 1 is a block diagram of an exemplary configuration of an information display system according to a first embodiment. This information display system 1 includes a cloud server 10, a map server 20, a user terminal 30, a business entity terminal 40, and a vehicle 50. The cloud server 10 and the other apparatuses such as the user terminal 30 are electrically connected to each other in a communicable manner with a communication line N.

The cloud server 10 is an information processing apparatus performing processing to display information demanded by a user on a map and the like. The cloud server 10 performs processing to display business information of a shop, business information of a mobile sales vehicle, and the like on map information displayed on a display of the user terminal 30, for example. A detailed description of the cloud server 10 will be given later.

The map server 20 is an information processing apparatus accumulating the map information indicating information representing maps. The map server 20 provides the map information displayed on the display of the user terminal 30 to the cloud server 10.

The user terminal 30 is an apparatus performing processing to display the information demanded by the user on the map information and the like. The user terminal 30 performs processing to receive input of a condition for narrowing down information desired to be displayed by the user and to display the information demanded by the user on the map information on the display in accordance with control of the cloud server 10, for example. The user terminal 30 is a mobile terminal such as a cellular phone, a smartphone, a tablet, or a notebook PC, for example.

The business entity terminal 40 is an information processing apparatus used by a business entity performing business. The business entity terminal 40 provides the information demanded by the user to the cloud server 10. The business entity terminal 40 transmits information input by the business entity to the cloud server 10 together with a business entity ID identifying the business entity. The business entity terminal 40 is a stationary type terminal such as a desktop PC or a mobile terminal such as a cellular phone, a smartphone, a tablet, or a notebook PC, for example.

The vehicle 50 is a vehicle that has mobile function and can perform business at various places (a mobile sales vehicle, for example). The vehicle 50 is an exemplary “movable.” The movable here refers to a mobile object. The movable includes mobile objects that can move such as a vehicle and objects moved by mobile objects.

The vehicle 50 include a GNSS receiver. The vehicle 50 has a unique vehicle ID identifying the vehicle 50. The vehicle 50 regularly receives Global Navigation Satellite System (GNSS) information and transmits it to the cloud server 10 together with the vehicle ID. The vehicle 50, when it travels, may transmit information on the moving speed of the vehicle 50 to the cloud server 10 together with position information.

The configuration of the information display system 1 is not limited to the above. The above example includes one each of the map server 20, the user terminal 30, the business entity terminal 40, and the vehicle 50; a plurality of these elements may be included, for example. Part or the whole of the functions of the map server 20 or the like may be implemented by the cloud server 10, for example.

Hardware Configuration of Cloud Server According to First Embodiment

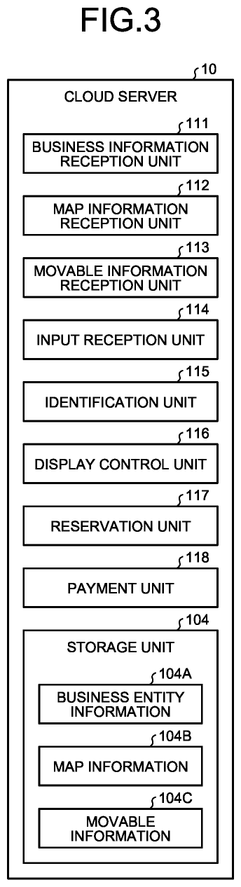

The following describes a hardware configuration of the cloud server 10 according to the first embodiment. FIG. 2 is a block diagram of an exemplary hardware configuration of the cloud server according to the first embodiment. The cloud server 10 includes a central processing unit (CPU) 101, a read only memory (ROM) 102, a random access memory (RAM) 103, and a storage unit 104. The components are electrically connected to each other via a bus line 105.

The CPU 101 controls operation of the entire cloud server 10. The ROM 102 stores therein various kinds of computer programs. The RAM 103 temporarily stores therein various kinds of data and the like. The CPU 101 develops the computer programs stored in the ROM 103 or the like in the RAM 103 and operates in accordance with the developed computer programs to control the cloud server 10.

The storage unit 104 stores therein various kinds of computer programs, data, and the like. In the present embodiment, the storage unit 104 stores therein business entity information 104A and map information 104B described below, for example. The storage unit 104 is a solid state drive (SSD) or a hard disk drive (HDD), which holds stored information even when power is shut down, for example.

Functional Configuration of Cloud Server According to First Embodiment

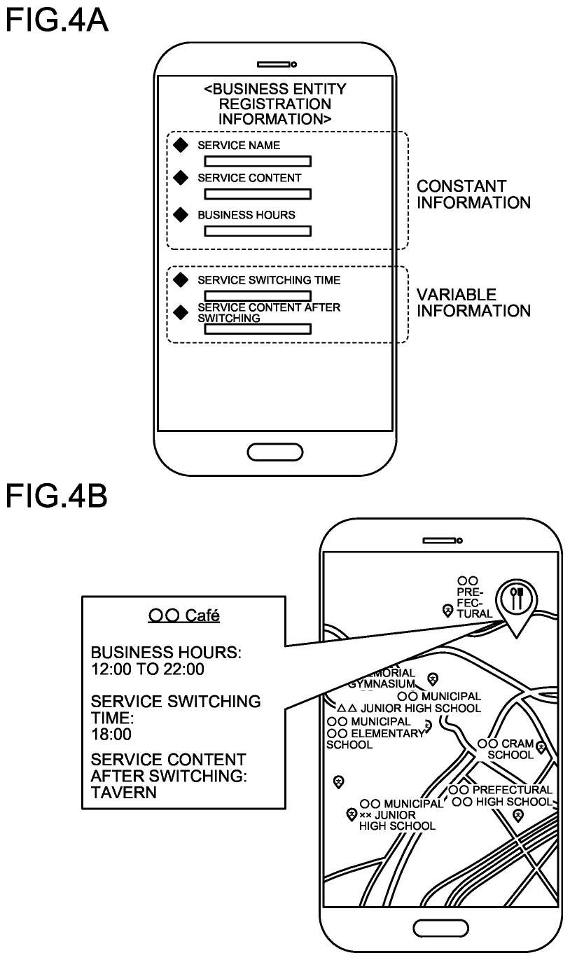

The following describes a functional configuration of the cloud server 10 according to the first embodiment. FIG. 3 is a block diagram of an exemplary functional configuration of the cloud server according to the first embodiment. The cloud server 10 includes a business information reception unit 111, a map information reception unit 112, a movable information reception unit 113, an input reception unit 114, an identification unit 115, a display control unit 116, a reservation unit 117, and a payment unit 118.

The business information reception unit 111 receives business information indicating information on business including information on an immovable or a movable. In the present embodiment, the business information reception unit 111 receives business information including business information of the immovable and business information of the movable input via the business entity terminal 40 by the business entity and transmitted to the cloud server 10 by the business entity terminal 40.

The business information received by the business information reception unit 111 is associated with identification information identifying the business entity transmitted together with the business information by the business entity terminal 40 and is stored as the business entity information 104A in the storage unit 104.

The business entity information 104A is information in which each identification information identifying an immovable or a movable is associated with information on the immovable or the movable. In the present embodiment, the business entity information 104A is information including business entity identification information identifying the business entity, identification information of the immovable, identification information of the vehicle 50, the business information of the immovable, business information of the vehicle 50, and movement information of the vehicle 50. The business entity information 104A is exemplary “associated information.”

The business information of the immovable refers to information including the name of the immovable, service content, business hours, a service switching time, and the location of the immovable, for example. The business information of the immovable may be different for different time slots when the service is switched. The business information of the immovable is exemplary “information on the immovable or the movable.”

The business information of the vehicle 50 refers to information including the name of the vehicle 50, service content, business hours, a service switching time, and the location of the vehicle 50, for example. The business information of the vehicle 50 may be different for different time slots when the service is switched.

The movement information of the vehicle 50 refers to information including an estimated movement time, a destination, and an estimated arrival time at the destination, for example. The business information of the vehicle 50 and the movement information of the vehicle 50 are each exemplary “information on the immovable or the movable.” The service content in the business information of the vehicle 50 referred to in this example includes services such as sales of articles and food and drink and provision of the food and drink.

The following describes the business entity information 104A in detail. In the present embodiment, the business entity information 104A is a collection of information associating the business entity ID identifying the business entity and information associating the business information of the immovable with each immovable ID identifying the immovable with each other or information associating the business entity ID and information associating the business information of the vehicle 50 and the movement information of the vehicle 50 with each vehicle ID identifying the vehicle 50 with each other.

Information associating the business entity ID and information associating the movement information of the vehicle 50 with each vehicle ID with each other may be configured as another piece of information.

The business entity ID is only required to be information that can identify the business entity and may automatically be assigned by the cloud server 10 or designated by the business entity at its choice. In the present embodiment, when the business entity performs information registration for the first time, the business entity terminal 40 requests assignment of the business entity ID from the cloud server 10, and the cloud server 10 assigns a character string that does not overlap with others as the business entity ID. The business entity ID may be issued and managed using a block chain technique. The block chain technique is used, whereby the business entity ID can be prevented from being falsified.

The immovable ID is information identifying the immovable; in the present invention, the map information 104B described below includes the immovable ID and position information of the immovable. The immovable ID may be issued and managed using a block chain technique. The block chain technique is used, whereby the immovable ID can be prevented from being falsified.

The vehicle ID is only required to be information that can identify the vehicle 50; a chassis number, a vehicle identification number, or the like can be the vehicle ID, for example. The vehicle ID may be issued and managed using a block chain technique. The block chain technique is used, whereby the vehicle ID can be prevented from being falsified.

In the present embodiment, the business entity information 104A is stored in the storage unit 104; the place for storing the business entity information 104A is not limited thereto. A server for storing therein the business information may separately be provided, for example.

The business entity information 104A is updated by inputting the business information using the business entity terminal 40 by the business entity and receiving the business information by the business information reception unit 111. The business information reception unit 111 receives the business information each time the information is transmitted from the business entity terminal 40 in order to constantly update the business entity information 104A to the latest state. The following describes the information to be input by the business entity separately for the immovable (a shop) and the movable (the vehicle 50).

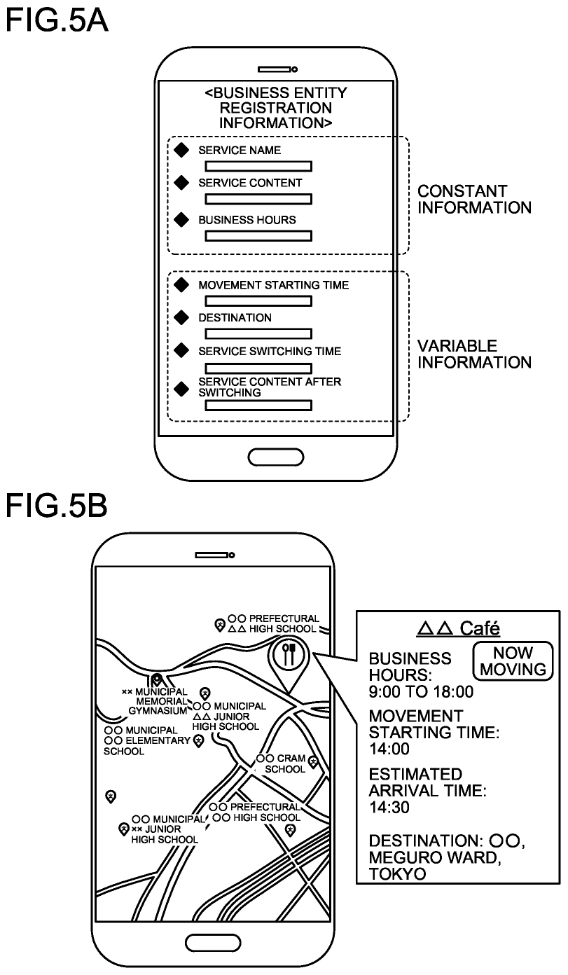

FIG. 4A is a diagram of an exemplary screen for the business entity to input business content and the like of the shop. This example enables input of a service name, service content, business hours, a service switching time, and service content after switching. Information other than these may be able to be input.

The service name refers to information indicating the name of the shop (“OO Cafe,” for example), for example. The service content is information indicating the content of the service provided by the shop (“cafe,” for example), for example. The business hours are information indicating the business hours of the shop (“12:00 to 22:00,” for example).

The service switching time is information indicating the time to change services (“18:00,” for example) when the service content is switched between time slots. The service content after switching is information indicating a service content after switching (“tavern,” for example). When the service content is switched, the business content (the service name, the service content, the business hours, and the like) different for different time slots may be able to be input.

In this example, among these pieces of information, the service name, the service content, and the business hours are each information that does not change at any timing at which it is referred to (constant information). On the other hand, the service switching time and the service content after switching are each information that can change depending on the timing at which it is referred to (variable information). The business entity registers the variable information at any time. The service is not necessarily switched, and the service switching time and the service content after switching are not necessarily required to be registered.

The information input by the business entity is stored as the business entity information 104A in the storage unit 104 and is displayed on the map displayed on the display of the user terminal 30 in accordance with a demand by the user.

FIG. 4B is a diagram of an exemplary screen displaying information on the shop registered by the business entity on the map. In this example, the display of the user terminal 30 displays the name of the shop, the business hours, the service switching time, and the service content after switching. In the drawing, the information is displayed outside the screen; but in fact, the information is displayed on the map.

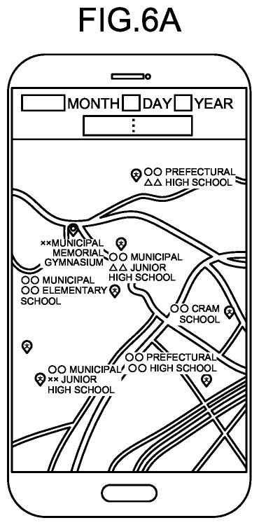

FIG. 5A is a diagram of an exemplary screen for the business entity to input business content and the like of the vehicle. This example enables input of a service name, service content, business hours, a movement starting time, destination, a service switching time, and a service content after switching. The service name, the service content, the business hours, the service switching time, and the service content after switching are similar to those of the case of the shop, and detailed descriptions thereof are omitted.

The movement starting time is information indicating the time at which movement when the vehicle 50 is expected to move starts (“14:00,” for example). The destination is information indicating a location where the service is expected to be provided after movement (“OO, Meguro Ward, Tokyo,” for example). In the case of the vehicle 50, the movement starting time, the destination, the service switching time, and the service content after switching are each variable information registered by the business entity at any time.

Like the case of the shop, the information input by the business entity is stored as the business entity information 104A in the storage unit 104 and is displayed on the map displayed on the display of the user terminal 30 in accordance with a demand by the user.

FIG. 5B is a diagram of an exemplary screen displaying information on the vehicle registered by the business entity on the map. As illustrated in FIG. 5B, when the vehicle 50 is moving at the timing at which the map is referred to, “NOW MOVING” is displayed below the service name. The estimated arrival time displays an estimated arrival time predicted from the moving speed of the vehicle 50, congestion information, and the like.

In this example, the display of the user terminal 30 displays the name of the vehicle 50, the information indicating moving, the business hours, the movement starting time, the estimated arrival time, and the destination. In the drawing, the information is displayed outside the screen; but in fact, the information is displayed on the map.

The above describes an example in which the vehicle 50 performs the business of a cafe; the business performed by the vehicle 50 is not limited thereto. The business performed by the vehicle 50 may be a mobile library, a mobile hotel, a mobile toilet, or a mobile smoking area, for example.

Referring back to FIG. 3, the description continues. The map information reception unit 112 receives the map information. In the present embodiment, the map information reception unit 112 receives map data as the map information from the map server 20. The map information received by the map information reception unit 112 is stored as the map information 104B in the storage unit 104. The map information 104B is updated each time the business entity information 104A is updated.

The movable information reception unit 113 receives movable information including identification information of the movable and position information indicating the position of the movable.

In the present embodiment, the movable information reception unit 113 receives the GNSS information received from the vehicle 50 as the position information of the vehicle 50 as the movable information of the vehicle 50 identified by the vehicle ID together with the vehicle ID. The movable information reception unit 113 may receive information on the moving speed of the vehicle 50 and the like as the movable information together with the vehicle ID and the position information of the vehicle 50.

The movable information of the vehicle 50 received by the movable information reception unit 113 is stored as movable information 104C in the storage unit 104. The movable information includes the vehicle ID of the vehicle 50, and thus the cloud server 10 refers to the business entity information 104A and can thereby identify the business information associated with the vehicle ID received as the movable information.

The input reception unit 114 receives input of a display condition such as designation of a date and time from the user. In the present embodiment, the input reception unit 114 receives input of designation of an area and the date and time as the display condition from the user. The user causes the display to display a map of an area information in which is desired, to designate the area. Designation of the area may be performed by input of an address or the like.

The user inputs the date and time to the screen to designate the date and time. The input reception unit 114 receives designation of the area and the date and time by the user performed as described above.

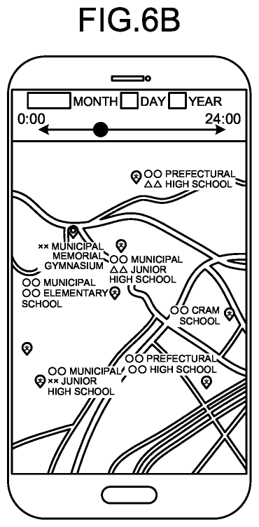

The method for designating the date and time by the user includes some methods. Examples of the method for designating the date and time include an input method. The input method is a method causing the user to input the date and time to an input box displayed at the upper part of the display of the user terminal 30 to designate the date and time. FIG. 6A is a diagram of an exemplary screen designating the date and time in the input method. The user uniquely inputs the date and time, information in which is desired to be known.

In the present embodiment, the input reception unit 114 receives designation of the date and time in the input method from the user; designation of the date and time may be received on another method such as a scroll method or a preview method.

The scroll method is a method receiving designation of the date and time using an input box and a slider. FIG. 6B is a diagram of an exemplary screen designating the date and time in the scroll method. The upper part of the display of the user terminal 30 displays the input box and the slider. The user inputs the date and time to the input box and then moves the slider rightward and leftward to designate the date and time.

In the scroll method, a certain period before and after the date and time input to the input box (1 hour before and after the designated date and time, for example) can be designated, and the display on the map changes in accordance with the movement of the slider. The scroll method is useful when the user desires to know not only the information with respect to a certain point in time but also the information with respect to a time before and after the certain point in time together.

The preview method is a method receiving designation of the date and time using an input box and a preview button. FIG. 6C is a diagram of an exemplary screen designating the date and time in the preview method. The display of the user terminal 30 displays the input box at the upper part and displays the preview button at the lower part. The user inputs the date and time to the input box and then pushes the preview button to designate the date and time.

In the preview method, a certain period before and after the date and time input to the input box (1 hour before and after the designated date and time, for example) can be designated, and when the user pushes the preview button, how the information on the map within the certain period changes is automatically reproduced. The preview method automatically reproduces how the information on the map changes and thus has the advantage of making it easier for the user to grasp the change in the information on the map within the certain period.

In the present embodiment, the input reception unit 114 receives input of designation of the area and the date and time from the user; the input reception unit 114 may receive only input of designation of the date and time. The input reception unit 114 may receive designation of services desired to be displayed in addition to designation of the area and the date and time from the user. Thus, the user can narrow down the information displayed on the display of the user terminal 30.

The identification unit 115 refers to the business entity information 104A in which each identification information identifying an immovable or a movable is associated with information on the immovable or the movable, to identify the information corresponding to the timing with respect to which the business entity information 104A is to be referred to, from among the information associated with the immovable or the movable on the map information 104B.

In the present embodiment, the identification unit 115 refers to the business entity information 104A to identify the business information of the immovable or the business information of the vehicle 50 and the movement information of the vehicle 50 corresponding to designation of the date and time designated by the user received by the input reception unit 114 with the immovable ID of the immovable on the map information 104B or the vehicle ID of the vehicle 50 as a key. The date and time designated by the user is exemplary “timing with respect to which the associated information is to be referred to.”

In the present embodiment, the identification unit 115 refers to the business entity information 104A at the timing at which the movable information reception unit 113 receives the movable information to identify the business information of the vehicle 50 and the movement information of the vehicle 50 associated with the vehicle ID included in the movable information received by the movable information reception unit 113. The timing at which the movable information reception unit 113 receives the movable information is exemplary “timing with respect to which the associated information is to be referred to.”

In the present embodiment, when the business information of the immovable are different for different time slots, the identification unit 115 first refers to the business entity information 104A to identify, with the immovable ID included in the map information 104B as a key, a plurality of pieces of business information of the immovable associated with the immovable ID. The identification unit 115 then identifies the business information of the immovable corresponding to the date and time received by the input reception unit 114 from among the pieces of business information of the immovable different for different time slots.

In the present embodiment, when the business information of the vehicle 50 are different for different time slots, the identification unit 115 first refers to the business entity information 104A and the movable information 104C to identify, with the vehicle ID included in the movable information 104C as a key, a plurality of pieces of business information of the vehicle 50 associated with the vehicle ID. The identification unit 115 then identifies the business information of the vehicle 50 corresponding to the date and time received by the input reception unit 114 from among the pieces of business information of the vehicle 50 different for different time slots.

The display control unit 116 performs control to display the information identified by the identification unit 115 at a position corresponding to the immovable or the movable associated with the information identified by the identification unit 115 in the map information 104B.

In the present embodiment, the display control unit 116 refers to the map information 104B and, when a position corresponding to the immovable identified by the immovable ID associated with the business information of the immovable identified by the identification unit 115 is present in the area received by the input reception unit 114 on the map information 104B, performs control to display the business information of the immovable identified by the identification unit 115 at the position.

In the present embodiment, when the user designates the current time as the date and time, the display control unit 116 refers to the map information 104B and the movable information 104C and, when a position corresponding to the position information of the vehicle 50 identified by the vehicle ID associated with the business information and the movement information of the vehicle 50 identified by the identification unit 115 is present in the area received by the input reception unit 114 on the map information 104B, performs control to display the business information and the movement information of the vehicle 50 identified by the identification unit 115 at the position on the map information 104B.

In the present embodiment, when the user designates a future date and time as the date and time, the display control unit 116 refers to the movement information of the vehicle 50 included in the business entity information 104A and the map information 104B and, when a position corresponding to the destination of the vehicle 50 included in the movement information of the vehicle 50 is present in the area received by the input reception unit 114 on the map information 104B on the date and time designated by the user, performs control to display the business information and the movement information of the vehicle 50 identified by the identification unit 115 at the position on the map information 104B.

When the vehicle 50 is moving at the current time and when the vehicle 50 is expected to be moving also on the date and time designated by the user, the display control unit 116 may perform control to display the business information and the movement information of the vehicle 50 identified by the identification unit 115 at a position of the vehicle 50 predicted from the moving speed of the vehicle 50, a road congestion state, and the like.

In the present embodiment, the display control unit 116 performs control to display the information identified by the identification unit 115 at a position corresponding to the position information of the vehicle 50 included in the movable information received by the movable information reception unit 113 in the map information 104B at the timing at which the movable information reception unit 113 receives the movable information.

In the present embodiment, the display control unit 116 performs control to change display of the immovable or the vehicle 50 on the map information 104B in accordance with the business information of the immovable, a position at which the vehicle 50 stands, or the business information of the vehicle 50 on the map information 104B. Examples of the position at which the vehicle 50 stands include parking lots, the inside of private land, and the inside of parks.

Specifically, when a symbol “P” representing a parking lot is displayed on the map information 104B, for example, when the vehicle 50 performing business stops at the parking lot to start business, the display control unit 116 performs control to display the symbol with the color thereof changed from green to red.

When a vehicle performing mobile hotel business stops at the parking lot to start operation, for example, the display control unit 116 performs control to display the symbol “P” representing a parking lot changed to “H” representing a hotel.

When a symbol representing a restaurant (a shop) is displayed on the map information 104B, for example, when the business category of the shop changes from restaurant to bar, the display control unit 116 performs control to display the symbol representing a restaurant changed to a symbol representing a bar. The above is by way of example, and the mode of changing symbols representing the immovable or the movable is not limited thereto.

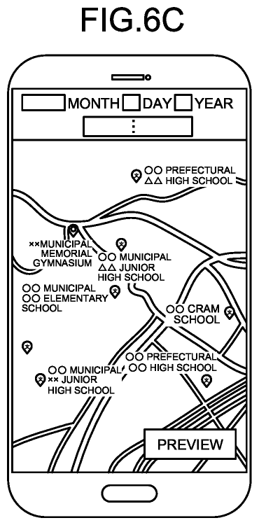

When the user clicks the symbol representing the parking lot at which the vehicle 50 performing business stands, for example, the display control unit 116 performs control to display, for a plurality of vehicles 50 standing at the parking lot, the business content of the respective vehicles 50 with symbols. FIG. 7 is a diagram of an exemplary screen representing the business content of the vehicles 50 standing at stopping positions with symbols.

When a parking lot is present within an area of a displayed map, the display control unit 116 first performs control to display a symbol “P” representing a parking lot on the map as in the right drawing. When the vehicles 50 performing business stand at this parking lot, when the user clicks this symbol “P,” the display control unit 116 performs control to display a screen representing the service content of the respective vehicles 50 standing within the parking lot with symbols as in the right drawing.

In this example, eight vehicles 50 stand within the parking lot. The eight symbols each represent the vehicle 50. The symbols vary by the services provided by the vehicles 50. When the user clicks any of the symbols on this screen, the display control unit 116 performs control to display the business information (the service name, the business hours, the movement starting time, the destination, and the like) of the vehicle 50. In addition to these, control to display a “reservation button” and a “payment button” may be performed.

In this example, when the symbol on the map is clicked, the display control unit 116 performs control to switch screen display; the display control unit 116 may perform control to switch screen display when the user pinches out the display to enlarge the symbol or the like.

The reservation unit 117 makes a reservation of the service provided by the vehicle 50. In the present embodiment, when the user clicks the symbol of the vehicle 50 that enables a service reservation, the display control unit 116 performs control to display the “reservation button.” When the user clicks the “reservation button,” the display control unit 116 performs control to display a screen for receiving input of information required for the reservation, and the reservation unit 117 makes a reservation of the service in accordance with the content input by the user.

The payment unit 118 performs payment processing for the service provided by the vehicle 50. In the present embodiment, when the user makes a reservation of a service that enables the payment processing, the display control unit 116 performs control to display the “payment button.” When the user clicks the “payment button,” the display control unit 116 performs control to display a screen for receiving input of information required for the payment processing, and the payment unit 118 performs the payment processing for the service in accordance with the content input by the user.

Thus, the user can make a reservation of and make a payment for the service simply by causing the display of the user terminal 30 to display the map and can thus smoothly receive provision of the service.

Processing by Information Display System According to First Embodiment

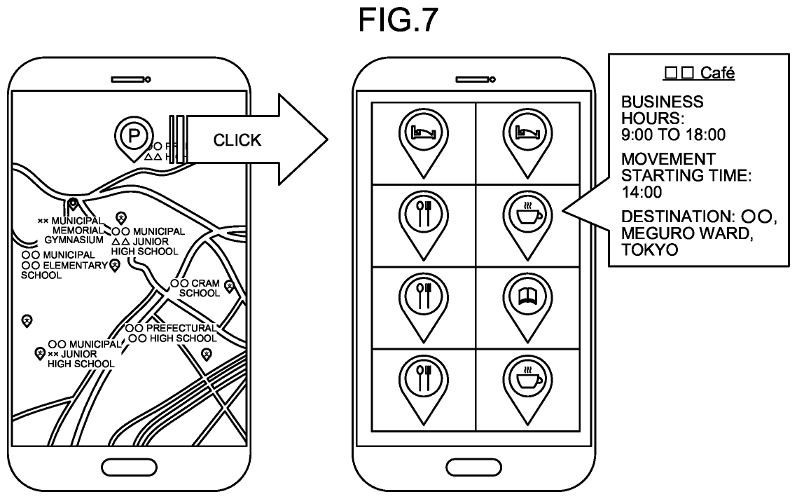

The following describes processing by the information display system 1 according to the first embodiment. FIG. 8 is a sequence diagram of exemplary processing by the information display system according to the first embodiment.

First, the business entity terminal 40 receives input of the business information including the business information of the immovable and the business information of the vehicle 50 from the business entity and transmits the received business information to the cloud server 10 together with the business entity ID (Step S11). The business information reception unit 111 of the cloud server 10 receives the business information transmitted from the business entity terminal 40 (Step S12).

The storage unit 104 stores therein the business information received by the business information reception unit 111 in association with the business entity ID as the business entity information 104A and updates the business entity information 104A to the latest state (Step S13).

The map information reception unit 112 receives the latest map information from the map server 20 (Step S14). The storage unit 104 stores therein the map information received by the map information reception unit 112 as the map information 104B and updates the map information 104B to the latest state (Step S15). The vehicle 50 receives the GNSS information (Step S16). The vehicle 50 transmits the received GNSS information to the cloud server 10 together with the vehicle ID.

The movable information reception unit 113 receives the GNSS information as the position information of the vehicle 50 as the movable information together with the vehicle ID (Step S17). The storage unit 104 stores therein the movable information received by the movable information reception unit 113 as the movable information 104C and updates the movable information 104C to the latest state (Step S18).

The user terminal 30 receives input of designation of the area and the date and time (the display condition) (Step S19). The input reception unit 114 of the cloud server 10 receives the display condition (Step S20). The identification unit 115 refers to the business entity information 104A to identify the information corresponding to the date and time received as the display condition by the input reception unit 114 (Step S21).

The display control unit 116, when a position corresponding to the immovable or the vehicle 50 associated with the information identified by the identification unit 115 is present within the area received as the display condition by the input reception unit 114, performs control to display the information identified by the identification unit 115 at the position (Step S22). The display of the user terminal 30 displays the information on the map information in accordance with the control of the display control unit 116 and ends the present processing (Step S23).

Effects of Information Display System According to First Embodiment

The following describes the effects of the information display system 1 according to the first embodiment. The information display system 1 according to the first embodiment includes the identification unit 115 referring to the business entity information 104A in which each immovable ID identifying the immovable or the vehicle ID identifying the vehicle 50 is associated with the business information, to identify the information corresponding to designation of the area and the date and time by the user from among the information on the immovable or the vehicle 50; and the display control unit 116 performing control to display the information identified by the identification unit 115 at the position corresponding to the immovable or the vehicle 50 associated with the information identified by the identification unit 115 in the map information 104B displayed on the display of the user terminal 30.

Thus, the information display system 1 according to the present embodiment can display the information on the vehicle 50 (the movable) on the date and time designated by the user (including the current time) on the map information. In addition, as to the immovable changing its business category between daytime and night time, the information display system 1 according to the present embodiment can display the information on the immovable on the date and time designated by the user on the map.

That is to say, the information display system 1 according to the present embodiment can display the information changing with the lapse of time such as the information on the movable or the information on the immovable changing its business category between time slots on the map with the change reflected. Consequently, the user can be prevented from missing the vehicle 50 providing a service desired by himself/herself even though it is nearby or from missing that the business category of the immovable changes between daytime and night time.

The information display system 1 according to the present embodiment includes the movable information reception unit 113 receiving the movable information including the vehicle ID and the position information of the vehicle 50 from the vehicle 50. The identification unit 115 refers to the business entity information 104A to identify the business information of the vehicle 50 associated with the vehicle ID included in the movable information received by the movable information reception unit 113, and the display control unit 116 performs control to display the business information of the vehicle 50 identified by the identification unit 115 at the position corresponding to the position information of the vehicle 50 included in the movable information received by the movable information reception unit 113.

Thus, the information display system 1 according to the present embodiment can display the business information of the vehicle 50 at the point in time at which the movable information reception unit 113 receives the movable information at the position corresponding to the position information of the vehicle 50 included in the movable information in the map information 104B displayed on the display of the user terminal 30.

That is to say, the user can simply know information such as where and what vehicle 50 is performing what business or until when the vehicle 50 is expected to perform business in the area at which it currently stands simply by causing the display of the user terminal 30 to display the map at the point in time at which the movable information reception unit 113 receives the movable information.

The display control unit 116 performs control to change display of the immovable or the vehicle 50 on the map information 104B in accordance with the business information of the immovable, the position at which the vehicle 50 stands, or the business information of the vehicle 50 on the map information 104B. When the vehicle 50 performing business stops at a parking lot, for example, the display control unit 116 performs control to display the “P” mark representing a parking lot with the color thereof changed.

Thus, the user can grasp whether the vehicle 50 performing business stands at a parking lot displayed on the map, what business the vehicle 50 is performing when the vehicle 50 stands, and the like simply by looking at the symbol (mark) on the map. The display control unit 116, when the user clicks the “P” mark representing a parking lot on the map, for example, performs control to display detailed information on the vehicle 50 standing at the parking lot and the like.

Thus, the user, when a plurality of vehicles 50 stand at a parking lot, for example, can easily obtain detailed information on each of the vehicles 50. The display control unit 116 can also perform control to display the “reservation button” and the “payment button” together with the detailed information on the vehicle 50. In this case, when the user pushes the “reservation button,” the reservation unit 117 makes a reservation of the service, whereas when the user pushes the “payment button,” the payment unit 118 makes a payment for the service.

With this configuration, the user can make a reservation of and make a payment for the service simply by displaying the map and can thus smoothly receive provision of the service.

### Second Embodiment

The following describes a second embodiment. Descriptions of parts common to the first embodiment described above are omitted as appropriate. In the first embodiment described above, in accordance with the demand by the user, the identification unit 115 identifies information to be displayed, and the display control unit 116 displays the information identified by the identification unit 115 on the map information 104B. In the present embodiment, however, in accordance with a demand by the business entity, the cloud server 10 delivers information to the business entity terminal 40.

Configuration of Information Display System According to Second Embodiment

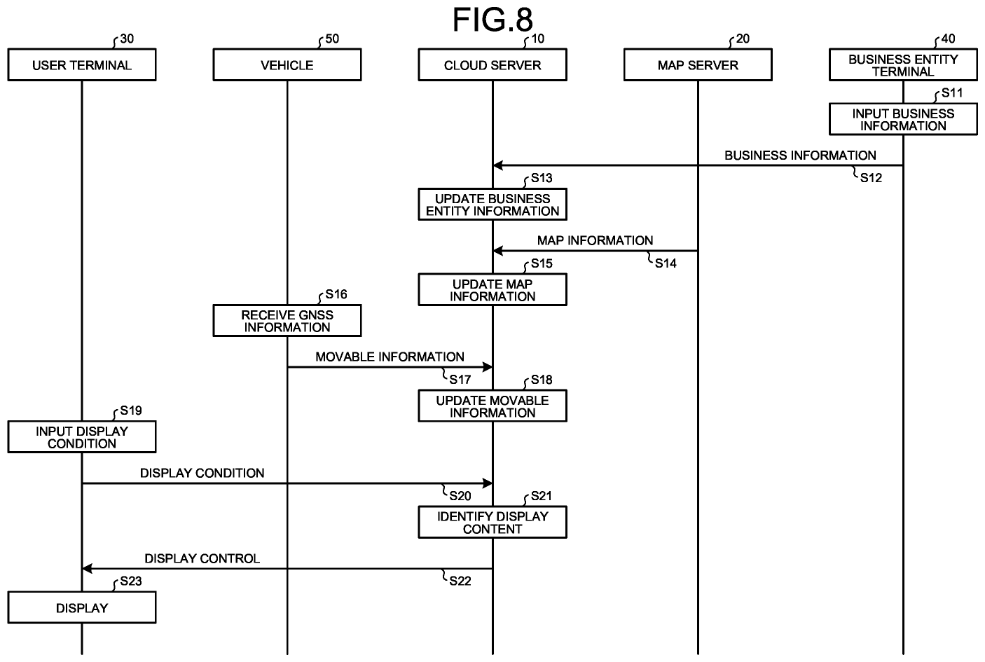

The following describes a configuration of the information display system 1 according to the second embodiment. FIG. 9 is a block diagram of an exemplary configuration of the information display system according to the second embodiment.

The information display system 1 according to the second embodiment includes a camera 60 connected to the cloud server 10 with a communication line N in addition to the cloud server 10, the map server 20, the user terminal 30, the business entity terminal 40, and the vehicle 50. The camera 60 regularly takes an image and transmits the taken image to the cloud server 10. The camera 60 is preferably provided at various places.

Functional Configuration of Cloud Server According to Second Embodiment

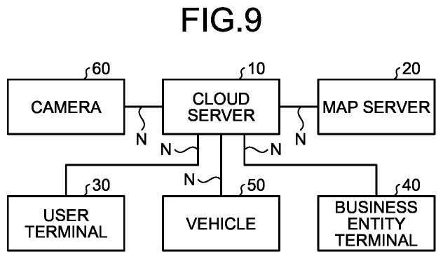

The following describes a functional configuration of the cloud server 10 according to the second embodiment. FIG. 10 is a block diagram of an exemplary functional configuration of the cloud server according to the second embodiment. The cloud server 10 according to the present embodiment includes the business information reception unit 111, the map information reception unit 112, the input reception unit 114, a people flow information reception unit 119, an attribute information reception unit 120, a sales information reception unit 121, a determining unit 122, and a prediction unit 123.

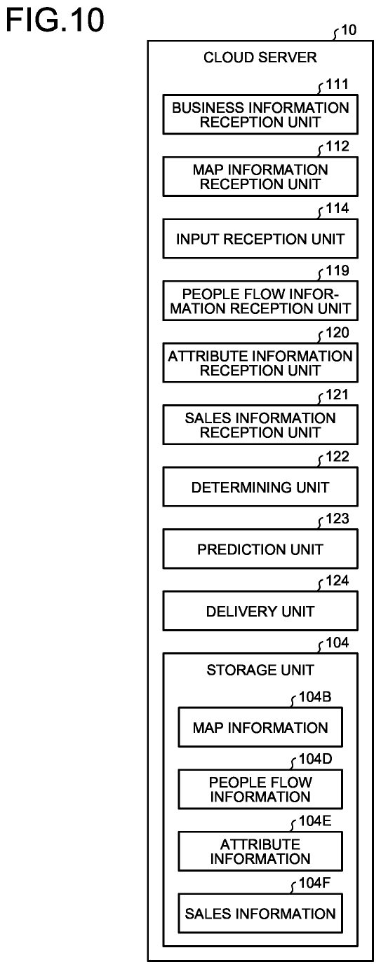

The business information reception unit 111 and the map information reception unit 112 are similar to those of the first embodiment, and thus descriptions thereof are omitted. The input reception unit 114 receives a delivery condition from the business entity. In the present embodiment, the input reception unit 114 receives information on notification frequency, a search area, and service content input via the business entity terminal 40 by the business entity. FIG. 11 is a diagram of an exemplary input screen for the delivery condition.

In this example, the business entity inputs the notification frequency, the search area, and the service content. The notification frequency is information indicating with what frequency the business entity desires to receive notifications. The search area is information indicating an area in which the business entity desires shop opening for business using the vehicle 50. The service content is information indicating the content of a service performed by the business entity with the vehicle 50. The cloud server 10, in accordance with these contents received by the input reception unit 114, performs information delivery to the business entity terminal 40.

The people flow information reception unit 119 receives people flow information on the map information 104B. In the present embodiment, the people flow information reception unit 119 receives the people flow information on the map information 104B based on the image transmitted by the camera 60, for example.

The people flow information reception unit 119 may receive the people flow information from position information of the user terminal 30 (a smartphone, for example). Furthermore, the people flow information reception unit 119 may receive the people flow information from both the image transmitted by the camera 60 and the position information of the user terminal 30.

The people flow information received by the people flow information reception unit 119 is stored as people flow information 104D in the storage unit 104. The people flow information 104D is a collection of information such as “There were ×× (the number of people) people moving from ΔΔ (location) to □□ (location) at OO (time).”

The attribute information reception unit 120 receives attribute information indicating the attribute of each person included in the people flow information received by the people flow information reception unit 119. In the present embodiment, the attribute information reception unit 120 receives information such as a posting history to a social networking service (SNS) and a WEB browser search history by each user included in the people flow information 104D as the attribute information indicating the attribute of each user from the user terminal 30.

The information received by the attribute information reception unit 120 is stored as attribute information 104E in the storage unit 104. The attribute information 104E is a collection of information such as “At OO (time) at ΔΔ (location), search for a cafe was performed.”

The sales information reception unit 121 receives sales information indicating information on sales including a business location, business hours, and sales. In the present embodiment, the sales information reception unit 121 receives the sales information indicating a location for providing a service, hours for providing the service, and sales of the service, and the like via the business entity terminal 40 from the business entity. The sales information received by the sales information reception unit 121 is stored as sales information 104F in the storage unit 104.

The sales information 104F is a collection of information such as “On the month and date of OO, OO to OO, at ΔΔ (location), service was provided to achieve sales of □□ yen.” Reception of the people flow information by the people flow information reception unit 119, reception of the attribute information by the attribute information reception unit 120, and reception of the sales information by the sales information reception unit 121 are preferably performed regularly in short spans of time.

The determining unit 122 determines a recommended business location of the movable based on the people flow information 104D. In the present embodiment, the determining unit 122 determines the recommended business location of the vehicle 50 based on the service content input via the business entity terminal 40 by the business entity, the people flow information 104D, and the attribute information 104E.

The determining unit 122, when the service content of the business entity is “cafe,” and when given an analysis result indicating “At OO today pedestrian traffic at ΔΔ (location) is predicted to increase, and at past OO at ΔΔ there were many people who searched for a cafe” from the people flow information 104D and the attribute information 104E, for example, determines ΔΔ as the recommended business location of the vehicle 50 at OO.

In the present embodiment, the determining unit 122 determines the recommended business location of the vehicle 50 based on the people flow information 104D and the attribute information 104E; the determining unit 122 may determine the recommended business location of the vehicle 50 only based on the people flow information 104D.

The prediction unit 123 predicts sales at the recommended business location determined by the determining unit 122 based on the people flow information 104D and the sales information 104F. In the present embodiment, the prediction unit 123 predicts the sales at the recommended business location determined by the determining unit 122 based on the service content input via the business entity terminal 40 by the business entity, the people flow information 104D, the attribute information 104E, and the sales information 104F.

In the present embodiment, the prediction unit 123 predicts the sales at the recommended business location based on the people flow information 104D, the attribute information 104E, and the sales information 104F; the prediction unit 123 may predict the sales at the recommended business location based on the people flow information 104D and the sales information 104F. The prediction unit 123 may predict the sales at the recommended business location by taking information on a competing business entity expected to perform business in the same area and in the same time slot or the like into account.

A delivery unit 124 delivers the recommended business location determined by the determining unit 122 to the business entity possessing the vehicle 50. The delivery unit 124 delivers sales prediction predicted by the prediction unit 123 to the business entity possessing the vehicle 50.

In the present embodiment, the delivery unit 124 delivers the recommended business location of the vehicle 50 determined by the determining unit 122 and the sales prediction at the recommended business location predicted by the prediction unit 123 to the business entity terminal 40 in accordance with the notification frequency input via the business entity terminal 40 by the business entity. The delivery unit 124 may deliver only the recommended business location of the vehicle 50 to the business entity.

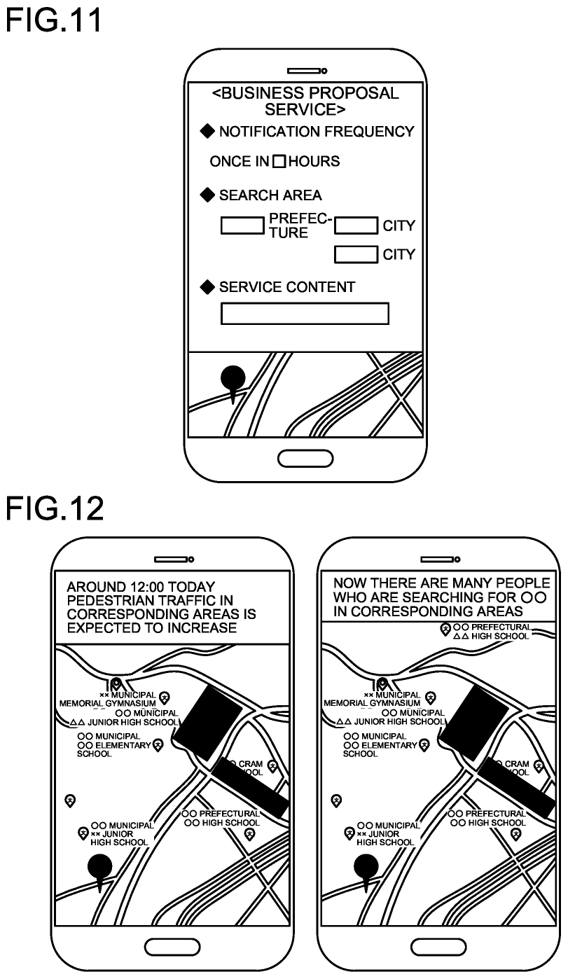

The following specifically describes the information to be delivered to the business entity. FIG. 12 is a diagram of an exemplary delivery screen to be delivered to the business entity. The left drawing is exemplary screen display to be delivered when a location with large pedestrian traffic is predicted from the people flow information 104D and the determining unit 122 determines the recommended business location of the vehicle 50. In this example, the display of the business entity terminal 40 displays a time slot in which business is recommended and recommended business locations.

Whereas, the right drawing is exemplary screen display to be delivered when the recommended business location of the vehicle 50 is determined from the people flow information 104D and the attribute information 104E. In this example, the display of the business entity terminal 40 displays areas in which there are many people who are searching for the service content input as the delivery condition via the business entity terminal 40 by the business entity at the current point in time.

In the present embodiment, the delivery unit 124 performs information delivery in accordance with the notification frequency input via the business entity terminal 40 or may deliver the information on the service provided by the business entity to the business entity terminal 40 at any time without receiving input of the notification frequency.

Processing by Information Display System According to Second Embodiment

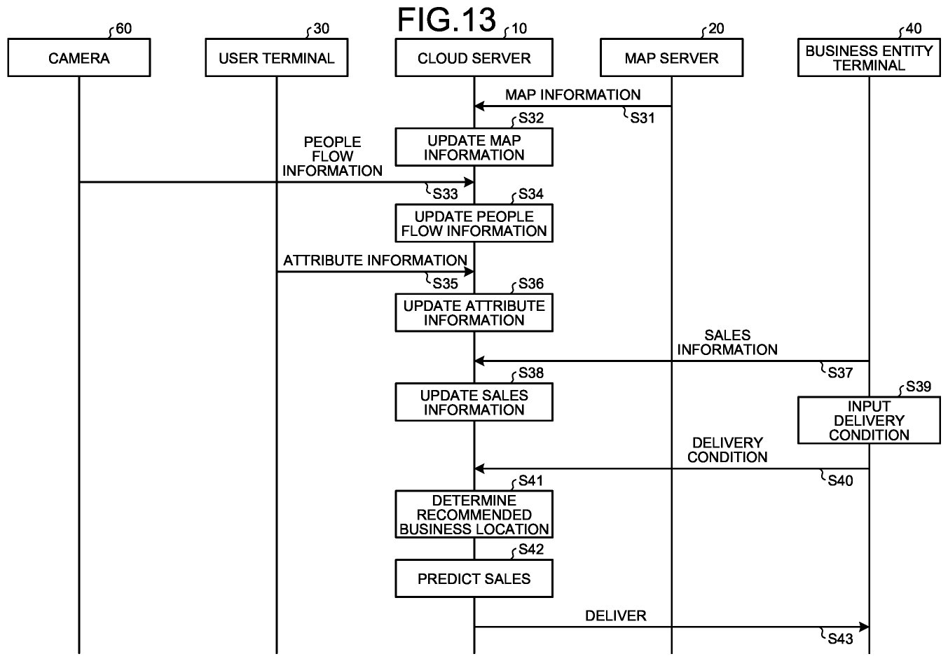

The following describes processing by the information display system 1 according to the second embodiment. FIG. 13 is a sequence diagram of exemplary processing by the information display system according to the second embodiment.

First, the map information reception unit 112 of the cloud server 10 receives the latest map information from the map server 20 (Step S31). The storage unit 104 stores therein the map information received by the map information reception unit 112 as the map information 104B and updates the map information 104B to the latest state (Step S32).

The people flow information reception unit 119 receives the people flow information based on the image transmitted from the camera 60 (Step S33). The storage unit 104 stores therein the people flow information received by the people flow information reception unit 119 as the people flow information 104D and updates the people flow information 104D to the latest state (Step S34).

The attribute information reception unit 120 receives the information such as the posting history to the SNS and the WEB browser search history as the attribute information from the user terminal 30 of each user included in the people flow information 104D (Step S35). The storage unit 104 stores therein the attribute information received by the attribute information reception unit 120 as the attribute information 104E and updates the attribute information 104E to the latest state (Step S36).

The sales information reception unit 121 receives the sales information from the business entity terminal 40 (Step S37). The storage unit 104 stores therein the sales information received by the sales information reception unit 121 as the sales information 104F and updates the sales information 104F to the latest state (Step S38).

The business entity terminal 40 receives input of the delivery condition including the notification frequency, the search area, and the service content from the business entity (Step S39). The input reception unit 114 of the cloud server 10 receives the delivery condition input via the business entity terminal 40 (Step S40). The determining unit 122 determines the recommended business location from the service content input as the delivery condition by the business entity, the people flow information 104D, and the attribute information 104E (Step S41).

The prediction unit 123 predicts the sales at the recommended business location determined by the determining unit 122 from the people flow information 104D, the attribute information 104E, and the sales information 104F (Step S42). The delivery unit 124 delivers the recommended business location determined by the determining unit 122 and the sales prediction predicted by the prediction unit 123 to the business entity terminal 40 in accordance with the notification frequency input via the business entity terminal 40 and ends the present processing (Step S43).

Effects of Information Display System According to Second Embodiment

The following describes the effects of the information display system 1 according to the second embodiment. The information display system 1 according to the second embodiment includes the people flow information reception unit 119 receiving the people flow information on the map information 104B, the attribute information reception unit 120 receiving the attribute information indicating the attribute of each person included in the people flow information received by the people flow information reception unit 119, the sales information reception unit 121 receiving the sales information indicating the information on sales including a business location, business hours, and sales, the determining unit 122 determining the recommended business location of the vehicle 50 from the people flow information 104D and the attribute information 104E, the prediction unit 123 predicting the sales at the recommended business location determined by the determining unit 122 from the people flow information 104D, the attribute information 104E, and the sales information 104F, and the delivery unit 124 delivering the recommended business location determined by the determining unit 122 and the sales prediction predicted by the prediction unit 123 to the business entity terminal 40 in accordance with the delivery condition input via the business entity terminal 40.

Thus, the business entity performing business by the vehicle 50 can easily obtain information on when and where a service should be provided, how much sales are expected when a service is provided for certain hours at a certain location, and the like.

The business entity receives information delivery from the cloud server 10, can thereby also obtain information such as at what location pedestrian traffic is currently large from the people flow information 104D or what service is currently being frequently searched for from the attribute information at any time, and can thus reduce the possibility of missing business chances. In addition, the business entity sets the notification frequency and can thereby also prevent the information from being delivered extremely frequently.

### Third Embodiment

The following describes a third embodiment. Descriptions of parts common to the first embodiment and the second embodiment described above are omitted as appropriate. In the second embodiment described above, in accordance with the demand by the business entity, the cloud server 10 delivers the information to the business entity terminal 40. In the present embodiment, however, when the business entity demands shop opening for certain hours at a certain location, whether shop opening is possible is judged, and when shop opening is possible, navigation for a required application procedure is performed.

Functional Configuration of Cloud Server According to Third Embodiment

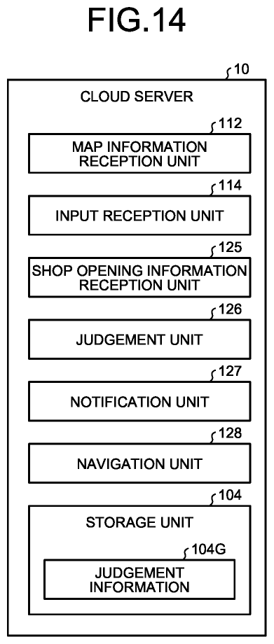

The following describes a functional configuration of the cloud server 10 according to the third embodiment. FIG. 14 is a block diagram of an exemplary functional configuration of the cloud server according to the third embodiment. The cloud server 10 according to the present embodiment includes the map information reception unit 112, the input reception unit 114, a shop opening information reception unit 125, a judgement unit 126, a notification unit 127, and a navigation unit 128.

The map information reception unit 112 is similar to that of the first embodiment and the second embodiment, and a detailed description is omitted. The input reception unit 114 receives various kinds of input. The input reception unit 114 receives input of a request for navigation from the business entity terminal 40, for example.

The shop opening information reception unit 125 receives shop opening information indicating information on a request for shop opening as information including a location, hours and service content of the shop the business entity desires to open. In the present embodiment, the shop opening information reception unit 125 receives contents of a temporary shop opening application (information such as desired hours for providing a service, a desired location for providing the service, and service content) input via the business entity terminal 40 by the business entity as the shop opening information.

The temporary shop opening application refers to transmitting information including the desired hours for providing the service, the desired location for providing the service, and the service content from the business entity terminal 40 to the cloud server 10 before a formal application by the business entity.

The judgement unit 126 performs judgement of the availability of a desired use location. In the present embodiment, the judgement unit 126 performs judgement of availability from the shop opening information received by the shop opening information reception unit 125 and judgement information 104G. Specifically, the judgement unit 126 refers to the judgement information 104G to judge location availability from the viewpoint of whether the location is legally available, whether a procedure will be completed by a desired date and time of use, whether nobody else uses the location on the date and time, and the like.

The judgement information 104G is information indicating information judging location availability. In the present embodiment, the judgement information 104G is a collection of the shop opening information received by the shop opening information reception unit 125, information disclosed by municipalities, public health centers, or police stations, and the like.

The cloud server 10 regularly receives the information disclosed by municipalities, public health centers, or police stations and stores it together with the shop opening information received by the shop opening information reception unit 125 as the judgement information 104G to update the judgement information 104G.

In the present embodiment, the judgement information 104G is stored in the storage unit 104; the place for storing the judgement information 104G is not limited thereto. A server for storing therein the judgement information may separately be provided, for example. The judgement information 104G is preferably updated regularly in short spans of time so that the judgement unit 126 can properly judge location availability.

The notification unit 127 notifies the business entity of availability based on the shop opening information and the judgement information 104G. In the present embodiment, the notification unit 127 transmits the availability judged by the judgement unit 126 to the business entity terminal 40 to provide notification of judgement of location availability. The notification unit 127, when the judgement unit 126 judges the location to be unavailable, provides notification of a nearby available area, notification of the fact that the location is available with a delayed date and time of use, or the like together with the notification of unavailability.

The navigation unit 128 performs navigation for a required procedure when the notification unit 127 notifies the business entity that the location is available. In the present embodiment, the navigation unit 128 performs navigation for the application procedure when the notification unit 127 provides notification of the fact that the location is available and when the business entity desires it.

Specifically, the navigation unit 128 performs processing to, when the business entity desires navigation, guide the business entity to a site for application or display how to proceed with the procedure, precautions, and the like on the display of the business entity terminal 40 as appropriate.

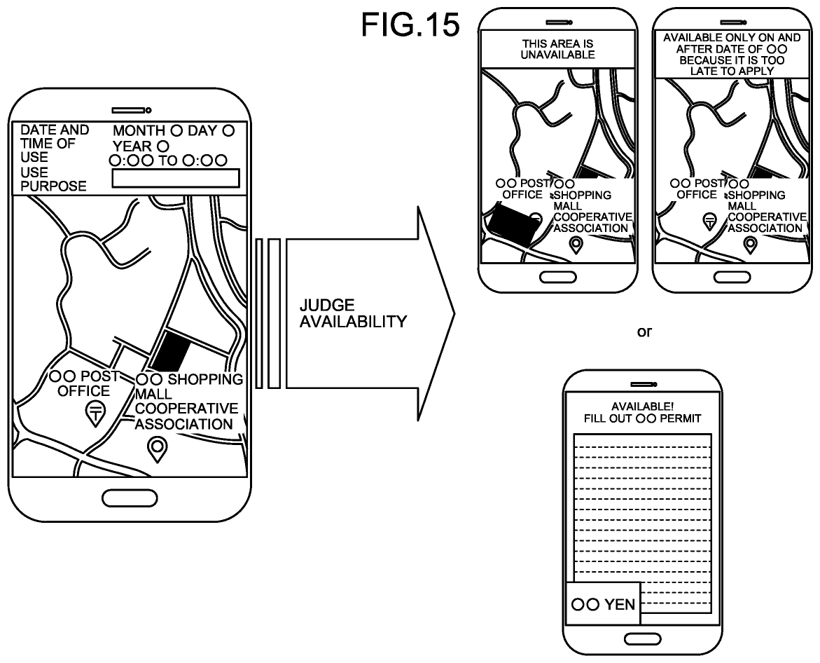

The following describes a procedure from the temporary shop opening application to the notification of availability. FIG. 15 is a diagram of an exemplary input screen for the temporary shop opening application and an exemplary judgement result of availability judgement. The left drawing is an exemplary input screen for the temporary shop opening application. In this example, the display of the business entity terminal 40 displays input boxes for a date and time of use and a use purpose and a map for selecting a use location.

The date and time of use is information indicating a time slot in which the business entity desires to provide a service. The use purpose is information indicating the content of the service that the business entity desires to provide. The use location is information indicating a location at which the business entity desires to provide the service.

In the present embodiment, the business entity causes the display of the business entity terminal 40 to display a map including a desired use location and clicks the position of the desired use location to designate the desired use location. The desired use location may be designated through input of an address or the like.

When the business entity inputs the shop opening information via the business entity terminal 40 to perform the temporary shop opening application, the shop opening information reception unit 125 of the cloud server 10 receives the shop opening information. The judgement unit 126 judges whether the location that the business entity desires to use is available on the date and time desired by the business entity based on the shop opening information and the judgement information 104G.

The right drawings of FIG. 15 illustrate exemplary content notified to the business entity terminal 40 by the notification unit 127. The upper right drawings illustrate exemplary content notified by the notification unit 127 when the judgement unit 126 judges the location to be unavailable. The notification unit 127, when the judgement unit 126 judges the location to be unavailable, and when there is any available location near the desired use location, for example, provides notification of the fact that there is an available location near the desired use location together with the notification of unavailability.

The notification unit 127, when the judgement unit 126 judges the location to be unavailable because of a time to be taken for getting permission (a lead time), for example, provides notification of the fact that the location is available on a later date (on and after the month and date of OO, for example) together with the notification of unavailability.

The notification unit 127, when the judgement unit 126 judges the location to be available, for example, provides notification of the cost required for the shop opening application together with the notification of availability. Then, the navigation unit 128 causes the display of the business entity terminal 40 to display a message such as “Request navigation for application procedure?” When a request for navigation is input from the business entity terminal 40, and the input reception unit 114 receives the fact, the navigation unit 128 performs navigation for the application procedure.

Processing by Information Display System According to Third Embodiment

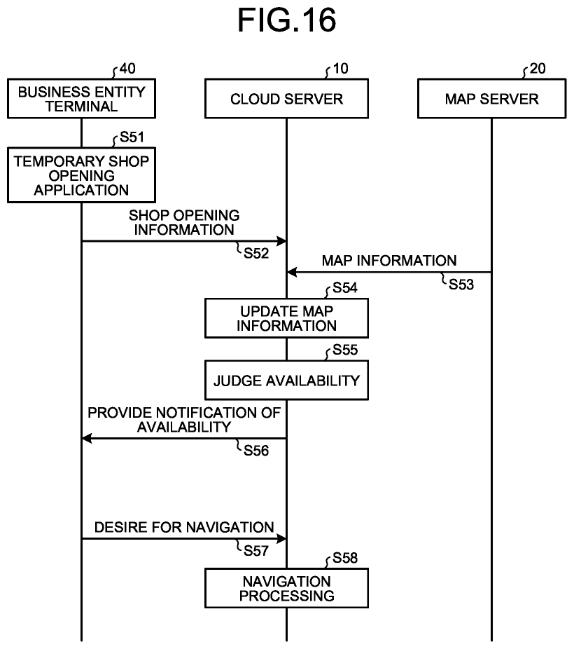

The following describes processing by the information display system 1 according to the third embodiment. FIG. 16 is a sequence diagram of exemplary processing by the information display system according to the third embodiment.

First, the business entity terminal 40 receives input of the information such as the date and time of use, the use purpose, and the use location from the business entity to perform the temporary shop opening application (Step S51). The shop opening information reception unit 125 of the cloud server 10 receives the information such as the date and time of use, the use purpose, and the use location input via the business entity terminal 40 as the shop opening information (Step S52).

The information reception unit 112 receives the map information from the map server 20 (Step S53). The storage unit 104 stores therein the map information as the map information 104B and updates the map information 104B to the latest state (Step S54).

The judgement unit 126 refers to the judgement information 104G to judge whether the service can be provided on the date and time desired by the business entity at the location desired by the business entity (Step S55). The notification unit 127 notifies the business entity terminal 40 of a judgement result by the judgement unit 126 (Step S56).

When the judgement unit 126 judges the location to be unavailable, the notification unit 127, when there is any available location near the desired use location or when the location is available on a later date, provides notification of the fact together with notification of unavailability and ends the present processing.

On the other hand, when the judgement unit 126 judges the location to be available, the notification unit 127 provides notification of the cost required for the application together with notification of availability. The navigation unit 128 causes the display of the business entity terminal 40 to display the message “Request for navigation for application procedure,” a “Yes” button, and a “No” button. When input is performed by the “No” button, the input reception unit 114 receives the fact that navigation is not requested and ends the present processing.

When input is performed by the “Yes” button, the input reception unit 114 receives the request for navigation (Step S57). The navigation unit 128 starts navigation processing for the application procedure and ends the present processing (Step S58).

Effects of Information Display System According to Third Embodiment

The following describes the effects of the information display system 1 according to the third embodiment. The information display system 1 according to the third embodiment includes the shop opening information reception unit 125 receiving the shop opening information indicating information on a request for shop opening as information including a location, hours and service content of the shop the business entity desires to open; and the notification unit 127 notifying the business entity of location availability based on the shop opening information received by the shop opening information reception unit 125 and the judgement information 104G as the information for judging location availability.

Thus, the business entity can know whether the service can be provided on the desired date and time at the desired location simply by inputting the “date and time of use,” the “use location,” the “use purpose,” and the like. That is to say, the business entity can simply know whether the service can be provided without doing research or the like on its own.

The information display system 1 according to the third embodiment includes the navigation unit 128 performing navigation for the required procedure when the notification unit 127 notifies the business entity that the location is available. The navigation unit 128 performs processing to guide the business entity to the site for application or display how to proceed with the procedure, precautions, and the like on the display of the business entity terminal 40 as appropriate, and thus the business entity can proceed with the procedure smoothly without being troubled.

The embodiments of the present disclosure have been described; the embodiments described above are presented by way of example and do not intend to limit the scope of the invention. These novel embodiments can be performed with various other modes, and various omissions, replacements, and modifications can be made within the scope not departing from the gist of the invention. These novel embodiments and modifications thereof are included in the scope and gist of the invention and are included in the invention described in what is claimed and equivalents thereof. Furthermore, components across different embodiments and modifications may be combined with each other as appropriate.

The effects of the embodiments described in the present specification are only by way of example and not limiting and other effects may be produced.

The present disclosure can display information on an immovable and a movable that changes with the lapse of time on a map. The effect described here is not necessarily limiting and may be any of the effects described in the present specification.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information display system comprising:
a memory; and
a hardware processor coupled to the memory, the hardware processor being configured to:
refer to associated information in which each identification information identifying an immovable or a movable is associated with information on the immovable or the movable, to identify information corresponding to a timing with respect to which the associated information is to be referred to, from among the information associated with the immovable or the movable on map information indicating information representing a map, and
perform control to display the identified information at a position corresponding to the immovable or the movable associated with the identified information in the map information.

2. The information display system according to claim 1, wherein
the processor is further configured to receive movable information including identification information and position information indicating a position of the movable from the movable, and
the processor is configured to:
refer to the associated information to identify the information associated with the identification information included in the received movable information; and
perform control to display the identified information at the position corresponding to the position information included in the received movable information in the map information.

3. The information display system according to claim 1, wherein the information includes business information of the immovable or business information of the movable.

4. The information display system according to claim 1, wherein
the processor is further configured to receive input of designation of a date and time from a user, and
the processor is configured to refer to the associated information to identify the information corresponding to the received date and time from among the information associated with the immovable or the movable on the map information.

5. The information display system according to claim 4, wherein a method of designation of the date and time includes an input method, a scroll method, and a preview method.

6. The information display system according to claim 4, wherein
the information includes a plurality of pieces of business information different for different time slots, and
the processor is configured to:
identify business information corresponding to the received date and time from among the plurality of pieces of business information associated with the immovable or the movable on the map information; and
perform control to display the identified business information.

7. The information display system according to claim 1, wherein the processor is configured to perform control to change display of the immovable or the movable on the map information in accordance with the information of the immovable, a position at which the movable stands, or the information of the movable on the map information.

8. The information display system according to claim 1, wherein the processor is further configured to
receive people flow information on the map information,
determine a recommended business location of the movable based on the people flow information, and
deliver the determined recommended business location to a business entity possessing the movable.

9. The information display system according to claim 8, wherein
the processor is further configured to receive attribute information indicating an attribute of each person included in the received people flow information, and
the processor is configured to determine the recommended business location of the movable based on the information of the movable, the people flow information, and the attribute information.

10. The information display system according to claim 9, wherein the processor is further configured to:
receive sales information indicating information on sales including a business location, business hours, and sales; and
predict sales at the determined recommended business location based on the people flow information and the sales information, and
the processor is configured to deliver the predicted sales to the business entity possessing the movable.

11. The information display system according to claim 10, wherein the processor is configured to predict the sales at the determined recommended business location based on the information of the movable, the people flow information, the attribute information, and the sales information.

12. The information display system according to claim 1, wherein the processor is further configured to
receive shop opening information indicating information on a request for shop opening as information including a location, hours and service content of a shop the business entity desires to open;
notify the business entity of availability based on the shop opening information and judgement information indicating information for judging location availability, and
perform navigation for a required procedure when notifying the business entity that the location is available.

13. An information display method comprising:
referring to associated information in which each identification information identifying an immovable or a movable is associated with information on the immovable or the movable, to identify information corresponding to a timing with respect to which the associated information is to be referred to, from among the information associated with the immovable or the movable on map information indicating information representing a map, and
performing control to display the identified information at a position corresponding to the immovable or the movable associated with the identified information in the map information.
